(19) United States
(12) Patent Application Publication
(10) Pub. No.: US 2025/0175100 A1
(43) Pub. Date: May 29, 2025

(54) TACTILE FEEDBACK SYSTEM

(71) Applicant: AAC Acoustic Technologies (Shanghai) Co., Ltd., Shanghai (CN)

(72) Inventors: Lijin Zhang, Shanghai (CN); Yulei Zhang, Shanghai (CN); Wangwang Hu, Shanghai (CN)

(21) Appl. No.: 18/633,457

(22) Filed: Apr. 11, 2024

Related U.S. Application Data
(63) Continuation of application No. PCT/CN2023/135200, filed on Nov. 29, 2023.

(51) Int. Cl. H02N 11/00; G08B 6/00

(52) U.S. Cl. CPC H02N 11/006; G08B 6/00

(57) ABSTRACT

Embodiments of the present disclosure provide a tactile feedback system for a terminal device. The tactile feedback system includes: at least one pressing portion which is disposed in the through hole and partially exposed out of the middle frame; at least one pressure sensor which is fixed on an inner side of the at least one pressing portion and is in one-to-one correspondence with the at least one pressing portion, and is configured to collect pressure parameters generated after the at least one pressing portion is pressed; and a tactile feedback vibrator configured to perform corresponding vibration feedback drive according to the pressure parameters collected by the at least one pressure sensor. Compared with the prior art, the tactile feedback system of the present disclosure can save installation space, adapt to multiple scenarios, and provide a good user experience.

### CROSS REFERENCE TO RELATED APPLICATIONS

The present application is a continuation of PCT Patent Application No. PCT/CN2023/135200, entitled “TACTILE FEEDBACK SYSTEM”, filed on Nov. 29, 2023, which is incorporated by reference herein in its entirety.

### TECHNICAL FIELD

Embodiments of the present disclosure relate to the technical field of tactile feedback, and more particularly to a tactile feedback system.

### BACKGROUND

Tactile feedback technology has been widely used in mobile phones and games, and has gained wonderful user experience and market response. Currently, almost all mobile phones have a motor inside to achieve vibration for alarms, incoming calls, and other reminders. Moreover, in mobile phone applications, the tactile feedback technology is also applied in some applications of mechanical buttons, such as volume buttons and power buttons. However, the effects of these buttons are relatively uniform, and thus cannot be adapted to specific scenarios to achieve particular effects, and thus cannot provide users with more direct and muscle memory-friendly prompts and feedback either.

In related technologies, tactile feedback is achieved through a button and a snap dome connected to the button. The function of the button is mainly achieved by conducting the circuit by pressing the snap dome, and the hand feeling is achieved through the force feedback during the deformation process of the snap dome. However, such configuration results in a uniform feedback effect of hand feeling and a short service life of the buttons. In addition, when buttons and linear motors are adopted to achieve virtual vibration feedback, one linear motor is provided under each button to provide tactile feedback, which results in a large space occupied by the motor and a complex drive circuit. Furthermore, the feedback effect of each button needs to be adjusted individually and is easily affected by assembly, resulting in poor feedback experience.

Therefore, it is desirable to provide a new tactile feedback system to solve the above technical problems.

### SUMMARY

Embodiments of the present disclosure are intended to provide a tactile feedback system with simple assembly and desirable virtual feedback experience.

In order to achieve the above object, embodiments of the present disclosure provide: a tactile feedback system for a terminal device. The terminal device includes a middle frame provided with a through hole running through the middle frame. The tactile feedback system includes:
at least one pressing portion which is disposed in the through hole and partially exposed out of the middle frame;
at least one pressure sensor which is fixed on an inner side of the at least one pressing portion and is in one-to-one correspondence with the at least one pressing portion, and is configured to collect pressure parameters generated after the at least one pressing portion is pressed; and,
a tactile feedback vibrator configured to perform corresponding vibration feedback drive according to the pressure parameters collected by the at least one pressure sensor, where the tactile feedback vibrator, the at least one pressure sensor, and the at least one pressing portion are rigidly connected to form an integral module, the integral module is flexibly connected to the middle frame through an elastomer, and a deformation direction of the elastomer is consistent with a vibration direction of the tactile feedback vibrator.

As an improvement, each of the at least one pressing portion includes a button body and at least one button cap protruding from the button body, where the button body is disposed on an inner side of the middle frame, the at least one button cap is disposed in the through hole, and a side, close to the tactile feedback vibrator, of each of the at least one button cap is provided with the respective pressure sensor; the button body is configured to generate strain after being pressed and recover.

As an improvement, a side, close to the tactile feedback vibrator, of the button body is recessed to form a clearance groove, the at least one pressing portion further includes the clearance groove, and the at least one pressure sensor is fixed inside the clearance groove; and
the tactile feedback system further includes a fixing sheet, where a side, close to the button body, of the fixing sheet is fixed to the button body, the at least one pressure sensor inside the clearance groove is covered by the fixing sheet, and the tactile feedback vibrator is fixed to a side, away from the at least one pressure sensor, of the fixing sheet.

As an improvement, the fixing sheet is an elastic sheet made of any one of silicone, foam, and plastic.

As an improvement, the elastomer is an elastic sheet made of metal or non-metal, or a flexible body made of any one of silicone, rubber, and foam.

As an improvement, each of the at least one pressure sensor is a piezoresistive, piezoelectric, or piezo-capacitive sensor that senses a pressing force through strain.

As an improvement, the tactile feedback system further includes a touch module configured for detecting gesture operations.

As an improvement, the vibration direction of the tactile feedback vibrator is perpendicular to a pressing direction of the pressing portion, the elastomer is arranged to be perpendicular to the fixing sheet, two ends of the elastomer are respectively fixed to the middle frame, and a peripheral side of the button body is fixed between the two ends of the elastomer.

As an improvement, the vibration direction of the tactile feedback vibrator is parallel to the pressing direction of the pressing portion, the elastomer is arranged to be parallel to the fixing sheet, two ends of the elastomer are respectively fixed to the middle frame, and the peripheral side of the button body is fixed between the two ends of the elastomer.

As an improvement, the tactile feedback vibrator is a vibration motor or a magnetic actuator.

Compared with the prior art, in the tactile feedback system of the present disclosure, the at least one pressing portion is disposed in the through hole and partially exposed out of the middle frame by providing a through hole in the middle frame of the terminal device; the at least one pressure sensor is fixed on the inner side of the at least one pressing portion and is in one-to-one correspondence with the at least one pressing portion, and is configured to collect pressure parameters generated after the at least one pressing portion is pressed; the tactile feedback vibrator is configured to perform corresponding vibration feedback drive according to the pressure parameters collected by the at least one pressure sensor; the tactile feedback vibrator, the at least one pressure sensor, and the at least one pressing portion are rigidly connected to form an integral module to reduce the volume of the module, so that the module can be applied in various simulation devices having virtual button-pressing effects that require local feedback. The module can be installed on electronic devices such as mobile phones, PADs, remote controls, and automobile consoles to provide tactile feedback for various application scenarios; the integral module is flexibly connected to the middle frame through the elastomer, and the deformation direction of the elastomer is consistent with the vibration direction of the tactile feedback vibrator, providing a good tactile feedback experience.

### BRIEF DESCRIPTION OF THE DRAWINGS

In order to illustrate the technical solutions in the embodiments of the present disclosure more clearly, the drawings used in the description of the embodiments are briefly described below. It is apparent that the drawings in the following description show only some embodiments of the present disclosure, and other drawings may be obtained by those of ordinary skill in the art based on these drawings without any creative efforts. In the drawings,

FIG. 1 is a schematic structural diagram of a terminal device according to an embodiment of the present disclosure;

FIG. 2 is an exploded view of the terminal device according to an embodiment of the present disclosure;

FIG. 3 is an exploded view of the tactile feedback system in FIG. 2;

FIG. 4 is a cross-sectional view of FIG. 1, taken along line A-A;

FIG. 5 is a partially enlarged view of portion B in FIG. 4; and

FIG. 6 is a schematic structural diagram of the Z-axis vibration of the tactile feedback system according to an embodiment of the present disclosure.

### DETAILED DESCRIPTION OF THE EMBODIMENTS

The technical solutions in the embodiments of the present disclosure will be described clearly and completely hereinafter in conjunction with the drawings in the embodiments of the present disclosure. Apparently, the described embodiments are only a part of the embodiments of the present disclosure, rather than all embodiments. Any other embodiments obtained by those of ordinary skill in the art based on the embodiments in the present disclosure without any creative efforts shall fall within the scope of protection of the present disclosure.

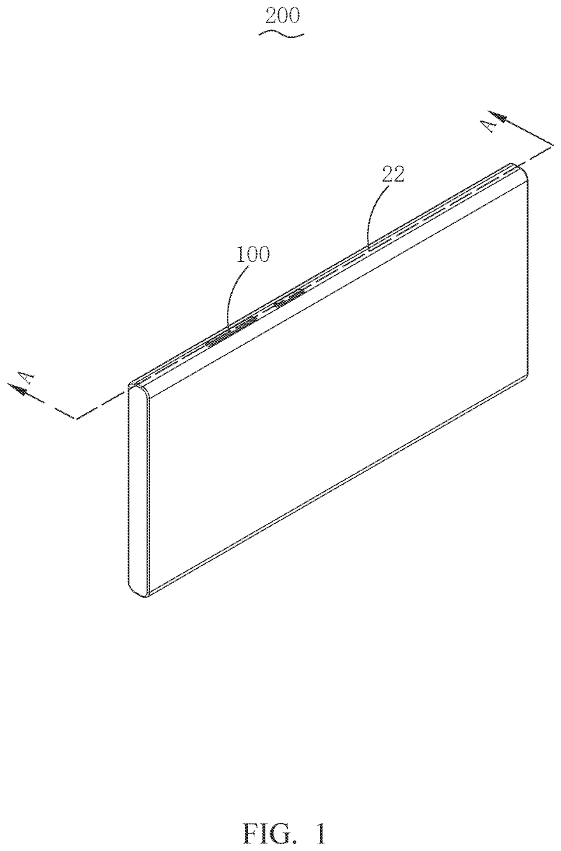

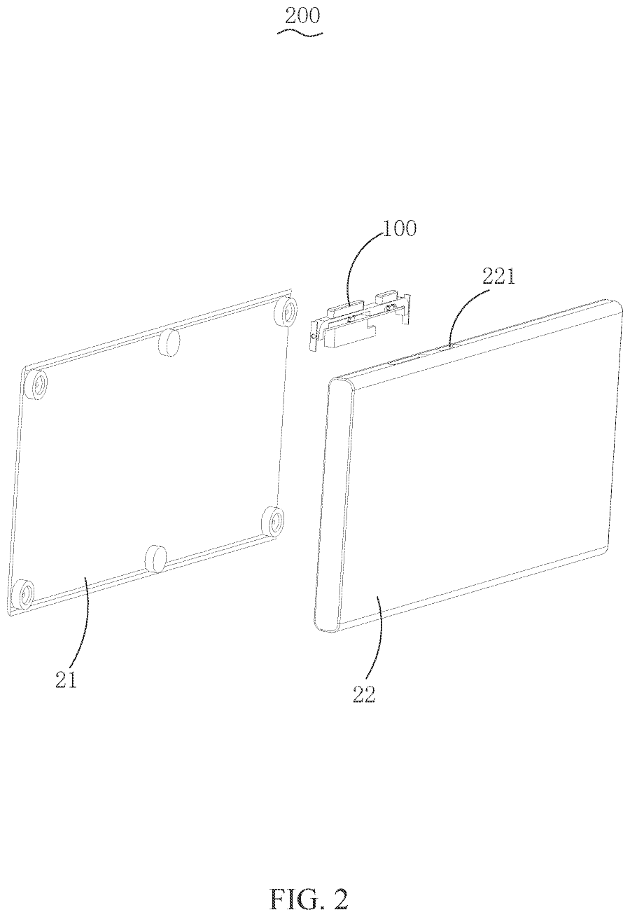

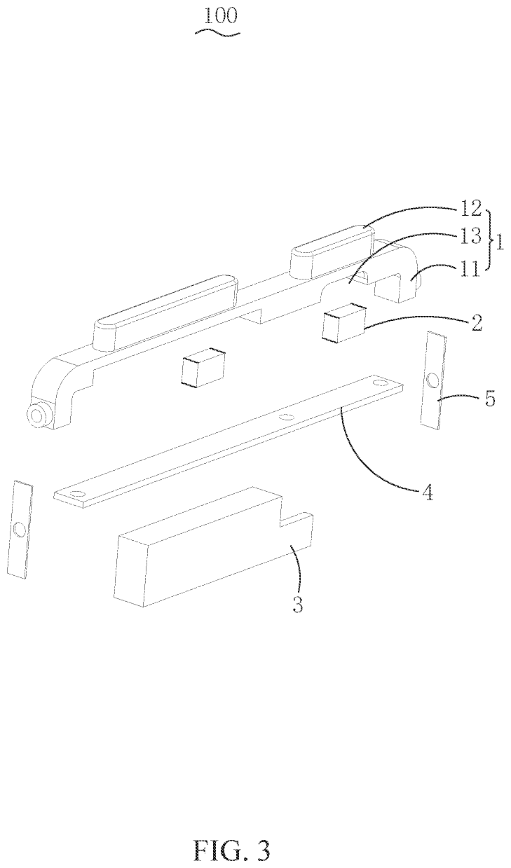

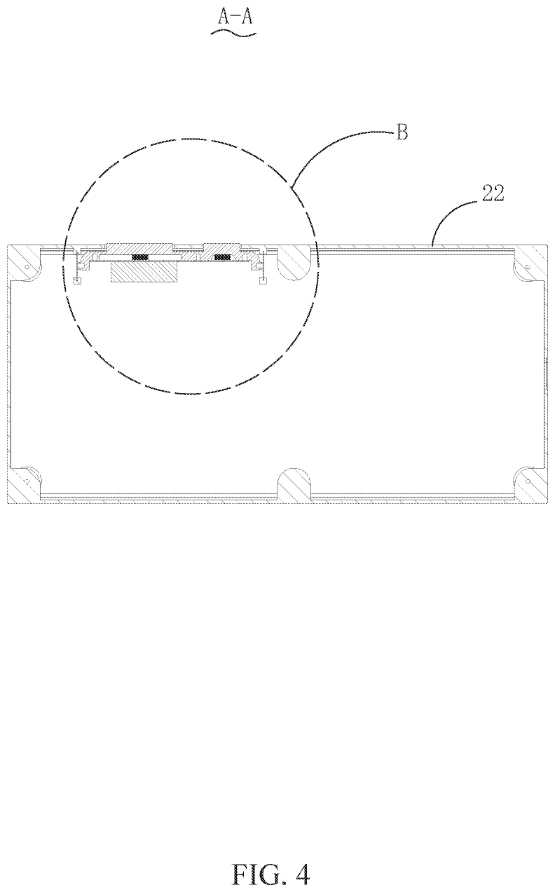

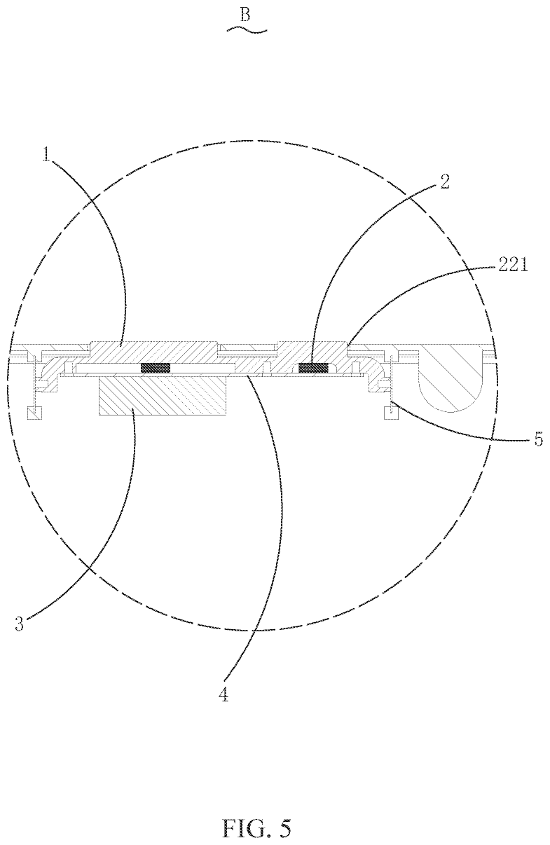

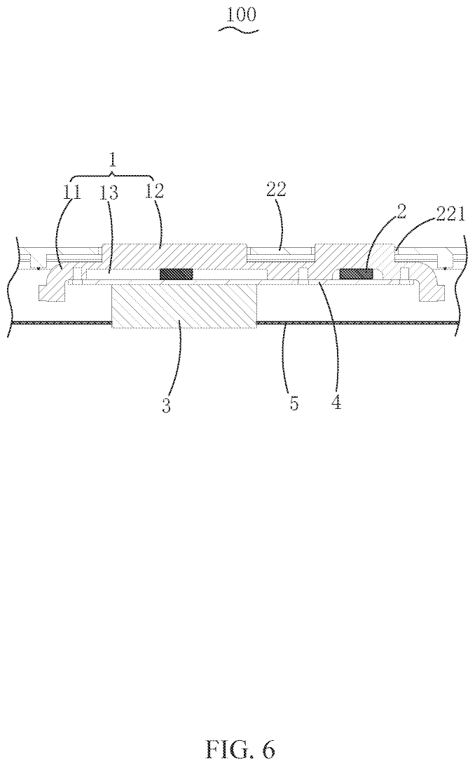

As shown in FIG. 1 to FIG. 6, embodiments of the present disclosure provide a tactile feedback system 100 for a terminal device 200. The terminal device 200 includes a bottom case 21 and a middle frame 22 covering and fixed to the bottom case 21. The terminal device 200 may be an electronic device such as mobile phone, PAD (tablet PC), remote control, and automobile console. The middle frame 22 is provided with a through hole 221 running through the middle frame. Optionally, the middle frame 22 is fixedly connected to the bottom case 21 through multiple screws.

The tactile feedback system 100 includes: a pressing portion 1, a pressure sensor 2, and a tactile feedback vibrator 3. The pressing portion 1 is configured to contact with the human body to achieve tactile pressure excitation, facilitating the pressure sensor 2 to sense external pressure.

At least one pressing portion 1 is provided, and the at least one pressing portion 1 is disposed in the through hole 221 and partially exposed out of the middle frame 22. Part of the pressing portion 1 is exposed out of the middle frame 22 to feel external tactile pressure, and the through hole 221 can also provide a guiding and limiting function for the pressing portion 1 to prevent the pressing portion 1 from deviating when the pressing portion 1 is subjected to force.

The pressure sensor 2 is fixed on an inner side of the pressing portion 1 and is in one-to-one correspondence with the pressing portion 1, and is configured to collect pressure parameters generated after the pressing portion 1 is pressed.

The tactile feedback vibrator 3 is configured to perform corresponding vibration feedback drive according to the pressure parameters collected by the pressure sensor 2. The tactile feedback vibrator 3, the pressure sensor 2, and the pressing portion 1 are rigidly connected to form an integral module. The integral module is flexibly connected to the middle frame 22 through an elastomer 5, and a deformation direction of the elastomer 5 is consistent with a vibration direction of the tactile feedback vibrator 3. Flexibly connecting the tactile feedback vibrator 3 to the middle frame 22 not only achieves local vibration, but also allows for the shielding or reduction of tactile feedback in undesired directions due to the flexible connection between the integral module and the middle frame 22. Further, the frequency response range of the tactile feedback system 100 can be expanded, and the vibration magnitude can be amplified at the resonance point of the tactile feedback system 100. The F0 (operating frequency) of the tactile feedback system 100 can be controlled to be above 300 Hz, so as to meet different vibration feeling requirements.

The vibration of the tactile feedback vibrator 3 may be along the X axis, Y axis, or Z axis. The X-axis and Y-axis are parallel to the pressing portion 1. The Z-axis is perpendicular to the pressing portion 1, and the direction of Z-axis vibration is consistent with the direction of the flexible connection.

Specifically, the tactile feedback vibrator 3, the pressure sensor 2, and the pressing portion 1 are rigidly connected to form an integral module to reduce the volume of the module, so that the module can be applied in various simulation devices having virtual button-pressing effects that require local feedback. The module can be installed on electronic devices such as mobile phones, PADs, remote controls, and automobile consoles to provide tactile feedback for various application scenarios.

As an improvement, when the pressing portion 1 requires a relatively large area, a new system adapted thereto can be established by connecting in series or parallel multiple tactile feedback modules having pressure feedback functions.

In this embodiment, the pressing portion 1 includes a button body 11 and at least one button cap 12 formed by protruding the button body 11 from the middle frame 22, where the button body 11 is disposed on an inner side of the middle frame 22, the at least one button cap 12 is disposed in the through hole 221, and a side, close to the tactile feedback vibrator 3, of each of the at least one button cap 12 is provided with the respective pressure sensor 2; the button body 11 can generate strain after being pressed and recover. By pressing the button cap 12, the pressure is transmitted through the button body 11 to the pressure sensor 2. The pressure sensor 2 collects the pressure parameters of the pressing and transmits the signal of the pressure parameters to the tactile feedback vibrator 3. The tactile feedback vibrator 3 outputs a corresponding vibration frequency based on the pressure parameters to provide tactile feedback for a good experience.

If the pressing portion 1 includes only one button cap 12, the pressing portion 1 is a single-cap button, and in the single-cap button, the button body 11 is disposed in the through hole, and the button cap 12 is disposed away from the middle frame 22. If the pressing portion 1 includes two button caps 12, the pressing portion 1 is a dual-cap button, and in the dual-cap button, the button body 11 is disposed on the inner side of the middle frame 22, and the two button caps 12 are disposed in the through hole 221. The present disclosure is of course not limited to the embodiments with one or two buttons, but may also include the embodiments with multiple buttons.

As an improvement, the button body 11 achieves the deforming and recovering functions through its own structure or through other structures.

In this embodiment, a side, close to the tactile feedback vibrator 3, of the button body 11 is recessed inwardly to form a clearance groove 13, the pressing portion 1 further includes the clearance groove 13, and the pressure sensor 2 is fixed inside the clearance groove 13. Such configuration can reduce the installation space of the pressure sensor 2, and further reduce the assembly space of the overall module.

The tactile feedback system 100 further includes a fixing sheet 4. A side, close to the button body 11, of the fixing sheet 4 is fixed to the button body 11, the pressure sensor 2 inside the clearance groove 13 is covered by the fixing sheet 4, and the tactile feedback vibrator 3 is fixed to a side, away from the pressure sensor 2, of the fixing sheet 4. The fixing sheet 4 is configured to sense and transmit the pressing force applied to the pressing portion 1. The tactile feedback vibrator 3 can drive two or more buttons, thereby reducing the volume of the module and reducing the occupied space.

As an improvement, the rigid connection between the pressure sensor 2 and the tactile feedback vibrator 3 may be a direct connection or an indirect connection. The way of connecting the pressure sensor 2 to the tactile feedback vibrator 3 by the fixing sheet 4 belongs to indirect rigid connection.

In this embodiment, the fixing sheet 4 is an elastic sheet made of any one of silicone, foam, and plastic that generates a corresponding strain after a force is applied on its surface and can recover.

In this embodiment, the elastomer 5 is an elastic sheet made of metal or non-metal, or a flexible body made of any one of silicone, foam and plastic. The elastomer 5 of different material parameters can be adapted to different motors or systems.

In this embodiment, the pressure sensor 2 is a piezoresistive, piezoelectric, or piezo-capacitive sensor that senses the pressing force through strain.

Optionally, the pressure sensor 2 can detect changes in resistance, voltage, or capacitance. For example, the pressure sensor 2 may be piezoresistive, piezoelectric or piezo-capacitive. The common feature is that the sensor can react to small deformations below 20 μm. Moreover, one or more pressure thresholds may be pre-set in the system.

In this embodiment, the tactile feedback system 100 further includes a touch module configured for detecting gesture operations, which can avoid some false operations such as triggering caused by pressure changes resulting from external forces such as falling and squeezing. However, in the absence of touch module, the pressure sensor 2 included therein may also be configured for detecting gesture operations such as sliding and multilevel pressure.

In this embodiment, the tactile feedback vibrator 3 is a vibration motor or a magnetic actuator.

In this embodiment, the vibration direction of the tactile feedback vibrator 3 is perpendicular to a pressing direction of the pressing portion 1, the elastomer 5 is arranged to be perpendicular to the fixing sheet 4, and two ends of the elastomer 5 are respectively fixed to the middle frame 22; a peripheral side of the button body 11 is fixed between the two ends of the elastomer 5. When the vibration direction of the tactile feedback vibrator 3 is perpendicular to the pressing direction of the pressing portion 1, vibration of the vibration motor has less impact on the pressure sensor 2. Through signal adaptation, the motor drive outputs different electrical signals to meet different application requirements. A pressure sensing drive receives signals from the pressure sensor 2 and recognizes gestures by processing.

Alternatively, the vibration direction of the tactile feedback vibrator 3 is parallel to the pressing direction of the pressing portion 1, the elastomer 5 is arranged to be parallel to the fixing sheet 4, two ends of the elastomer 5 are respectively fixed to the middle frame 22, and the peripheral side of the button body 11 is fixed between the two ends of the elastomer 5. When the vibration direction of the tactile feedback vibrator 3 is parallel to the pressing direction of the pressing portion 1, it is required to particularly design the fixing sheet 4 to prevent the vibration motor from transmitting strain to the sensor during vibration. Through signal adaptation, the vibration motor drive outputs different electrical signals to meet different application requirements. A pressure sensing drive receives signals from the pressure sensor 2 and recognizes gestures by processing.

Compared with the prior art, in the tactile feedback system of the present disclosure, the at least one pressing portion is disposed in the through hole and partially exposed out of the middle frame by providing a through hole in the middle frame of the terminal device; the at least one pressure sensor is fixed on the inner side of the at least one pressing portion and is in one-to-one correspondence with the at least one pressing portion, and is configured to collect pressure parameters generated after the at least one pressing portion is pressed; the tactile feedback vibrator is configured to perform corresponding vibration feedback drive according to the pressure parameters collected by the at least one pressure sensor; the tactile feedback vibrator, the at least one pressure sensor, and the at least one pressing portion are rigidly connected to form an integral module to reduce the volume of the module, so that the module can be applied in various simulation devices having virtual button-pressing effects that require local feedback. The module can be installed on electronic devices such as mobile phones, PADs, remote controls, and automobile consoles to provide tactile feedback for various application scenarios; the integral module is flexibly connected to the middle frame through the elastomer, and the deformation direction of the elastomer is consistent with the vibration direction of the tactile feedback vibrator, providing a good tactile feedback experience.

The above description only illustrates embodiments of the present disclosure. It should be noted that for those of ordinary skill in the art, improvements can still be made thereto without departing from the inventive concept of the present disclosure, and these improvements still fall within the scope of protection of the present disclosure.

What is claimed is:

1. A tactile feedback system for a terminal device, the terminal device comprising a middle frame provided with a through hole running through the middle frame, wherein the tactile feedback system comprises:
at least one pressing portion which is disposed in the through hole and partially exposed out of the middle frame;
at least one pressure sensor which is fixed on an inner side of the at least one pressing portion and is in one-to-one correspondence with the at least one pressing portion, and is configured to collect pressure parameters generated after the at least one pressing portion is pressed; and,
a tactile feedback vibrator configured to perform corresponding vibration feedback drive according to the pressure parameters collected by the at least one pressure sensor, wherein the tactile feedback vibrator, the at least one pressure sensor, and the at least one pressing portion are rigidly connected to form an integral module; the integral module is flexibly connected to the middle frame through an elastomer, and a deformation direction of the elastomer is consistent with a vibration direction of the tactile feedback vibrator.

2. The tactile feedback system according to claim 1, wherein
each of the at least one pressing portion comprises a button body and at least one button cap protruding from the button body, wherein the button body is disposed on an inner side of the middle frame, the at least one button cap is disposed in the through hole, and a side, close to the tactile feedback vibrator, of each of the at least one button cap is provided with a respective pressure sensor of the at least one pressure sensor; and
the button body is configured to generate strain after being pressed and recover.

3. The tactile feedback system according to claim 2, wherein
the at least one pressing portion further comprises a clearance groove recessed from a side, close to the tactile feedback vibrator, of the button body; and
the tactile feedback system further comprises a fixing sheet, wherein a side, close to the button body, of the fixing sheet is fixed to the button body, the at least one pressure sensor inside the clearance groove is covered by the fixing sheet, and the tactile feedback vibrator is fixed to a side, away from the at least one pressure sensor, of the fixing sheet.

4. The tactile feedback system according to claim 3, wherein
the fixing sheet is an elastic sheet made of any one of silicone, foam, and plastic.

5. The tactile feedback system according to claim 1, wherein
the elastomer is an elastic sheet made of metal or non-metal, or a flexible body made of any one of silicone, rubber, and foam.

6. The tactile feedback system according to claim 1, wherein
each of the at least one pressure sensor is a piezoresistive, piezoelectric, or piezo-capacitive sensor that senses a pressing force through strain.

7. The tactile feedback system according to claim 1, wherein
the tactile feedback system further comprises a touch module configured for detecting gesture operations.

8. The tactile feedback system according to claim 3, wherein
the vibration direction of the tactile feedback vibrator is perpendicular to a pressing direction of the at least one pressing portion, the elastomer is arranged to be perpendicular to the fixing sheet, two ends of the elastomer are respectively fixed to the middle frame, and a peripheral side of the button body is fixed between the two ends of the elastomer.

9. The tactile feedback system according to claim 3, wherein
the vibration direction of the tactile feedback vibrator is parallel to a pressing direction of the at least one pressing portion, the elastomer is arranged to be parallel to the fixing sheet, two ends of the elastomer are respectively fixed to the middle frame, and a peripheral side of the button body is fixed between the two ends of the elastomer.

10. The tactile feedback system according to claim 1, wherein
the tactile feedback vibrator is a vibration motor or a magnetic actuator.
